(19) United States
(12) Patent Application Publication
(10) Pub. No.: US 2018/0191766 A1
(43) Pub. Date: Jul. 5, 2018

(54) DYNAMIC ASSESSMENT AND CONTROL OF SYSTEM ACTIVITY

(71) Applicant: Ziften Technologies, Inc., Austin, TX (US)

(72) Inventors: Ryan Holeman, Austin, TX (US); Al Hartmann, Round Rock, TX (US); Josh Harriman, Austin, TX (US); Josh Applebaum, Austin, TX (US)

(21) Appl. No.: 15/802,074

(22) Filed: Nov. 2, 2017

Related U.S. Application Data
(60) Provisional application No. 62/442,205, filed on Jan. 4, 2017.

(51) Int. Cl. H04L 29/06; G06F 21/62

(52) U.S. Cl. CPC H04L 63/1433; H04L 63/1425; H04L 63/1441; H04L 63/20; H04L 63/1416; G06F 21/6245

(57) ABSTRACT

Techniques are disclosed relating to monitoring computer system activity. In some embodiments, a computing device receives information from observation instrumentation that monitors a plurality of observation points in a computer system. The information includes information identifying activities occurring in the computer system and observed by the observation instrumentation. The computing device determines, from the received information, a risk profile associated with the computer system and, based on the risk profile, adjusts how the observation instrumentation monitors the plurality of observation points. In some embodiments, the received information includes information about one or more user activity risk factors, system risk factors, application risk factors, contact risk factors and/or enterprise risk factors. In some embodiments, based on the risk profile, the computing device causes a control action to be taken with respect to one or more components in the computer system.

This application claims the benefit of U.S. Prov. Appl. No. 62/442,205 filed on Jan. 4, 2017, which is incorporated by reference herein in its entirety.

### BACKGROUND

### Technical Field

This disclosure relates generally to computer security, and, more specifically, to monitoring system activity.

### Description of the Related Art

Many information technology organizations may monitor various aspects about computer systems to improve system security and/or resource utilization. This may include monitoring the processes running in a computer system, which may be used for virus checking or ensuring that employees are not executing unauthorized software. In a computer network context, this monitoring may include collecting various forms of information about the traffic being communicated by network devices such as information collected using NETFLOW technology, which is a feature introduced on CISCO routers that provides the ability to collect Internet Protocol (IP) traffic as it enters or exits an interface of a network device. Various devices in the network may facilitate the collection and analysis of information, including collectors and analyzers, which may process information to gain insight into a computer system's activities.

### BRIEF DESCRIPTION OF THE DRAWINGS

FIG. 1 is a block diagram of a computer network with flow collection and analysis devices and endpoint computer systems with endpoint analysis agents according to the present disclosure.

FIG. 2 is a block diagram of an exemplary endpoint computer system illustrating various layers at which an endpoint analysis agent capability may reside.

FIG. 3 is a block diagram of an exemplary endpoint computer system according to the present disclosure.

FIG. 4 is a block diagram depicting a logical arrangement of an exemplary endpoint analysis agent.

FIG. 5 is a block diagram depicting an exemplary logical arrangement of a network flow analyzer.

FIG. 6 is a block diagram of an exemplary system configured to perform dynamic assessment of computer system activity.

FIG. 7 is a flow diagram of an exemplary method for dynamically assessing computer system activity based on a risk profile for a computer system.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. An “endpoint computer system that is configured to collect information about computing activity” is intended to cover, for example, a device or system that performs this function during operation, even if the device/system in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

Computer system analysis has traditionally been performed in a static manner. That is, hardware and/or software may monitor multiple observation points in a computer system to observe various aspects about that system, and report observation information to an analyzer that processes the information. Any insight gleaned by the analyzer, however, is not fed back to control how the monitoring is performed at the observations points. Accordingly, if the analyzer begins processing observation information that indicates a computer system is at a significant risk of being under attack or is currently being attacked, the hardware and/or software monitoring these points continues in the same manner as it did before.

The present inventors recognize that this static approach unnecessary results in a compromise between monitoring intensity and system performance. For example, a network may have high value assets that are periodically attacked by malicious entities. As such, an enterprise may adopt an aggressive policy for monitoring those assets in order to obtain greater quantities of observation information usable to thwart an attack. The enterprise may also adopt an aggressive control policy that takes aggressive actions in the event of attack detection. In doing so, however, the intense monitoring may consume valuable resources (e.g., resources at the source of monitoring, network resources, analysis resources, etc.), and this consumption may occur at times when a system is not even under attack. Aggressive actions that further hinder performance may also be taken at a time when the system is not being attacked. On the other hand, if the enterprise adopts a laxer policy of monitoring or control, important observation information may be missed or delayed when an attack is underway, and weak control actions may be taken when under attack.

In contrast to this static approach for monitoring, the present disclosure describes embodiments in which assessment of system activity is performed dynamically using an algorithm that considers multiple metrics. As will be described below in greater detail, in various embodiments, an enterprise may define a policy specifying how observation points are supposed to be monitored in a computer system such as the enterprise's network. Based on this policy, observation instrumentation may monitor various aspects associated with these observation points and provide corresponding observation data that includes, for example, data usable to identify potential risks as well as data about system performance and the operational state of the system. In various embodiments, an analyzer then processes this information and determines assessments about the risk of the system, the performance of the system, and the operational state of the system. Based on these assessments and the defined policy, the disclosed algorithm may make adjustments to how observation instrumentation monitors the observation points. The algorithm may also control what corrective actions are taken when problems are detected in order to mitigate or thwart these problems. For example, if a high-risk assessment is determined for a set of network components, adjustments may be made to cause observation points associated with those components to be monitored more aggressively. If security issues are detected, the algorithm may take more aggressive control actions to account for those issues. On the other hand, if a network component is determined to be performing poorly and is given a low risk assessment, adjustments may be made to relax the monitoring associated with that component and refrain from taking control actions that further hinder its performance.

Using a dynamic approach for analyzing system activity may offer conservable advantages over prior static approaches. As one benefit, system resources may be more efficiently used as aggressive monitoring may be performed only when it is warranted. Still further, in the event of an attack, targeted monitoring may be performed—i.e., aggressively monitoring may be performed for components under attack, but not for components that are uninvolved with the attack. Another benefit is that greater quantity and quality information can be collected when it is appropriate. That is, aggressive monitoring, which may not be tolerated under a static monitoring scheme, may be acceptable for a short time when an attack is ongoing.

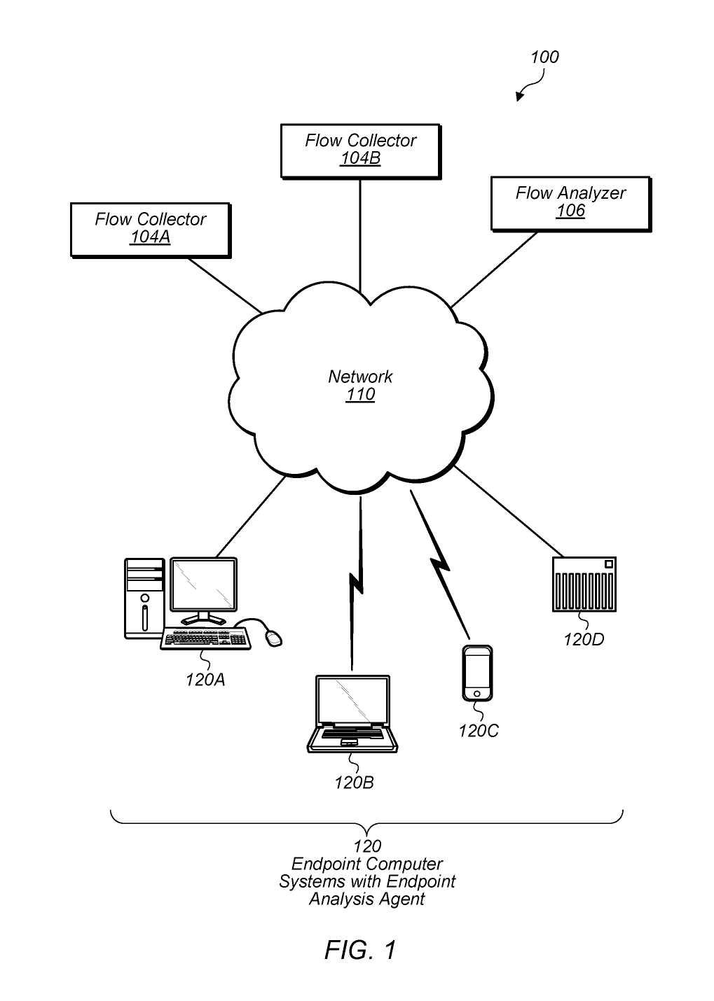

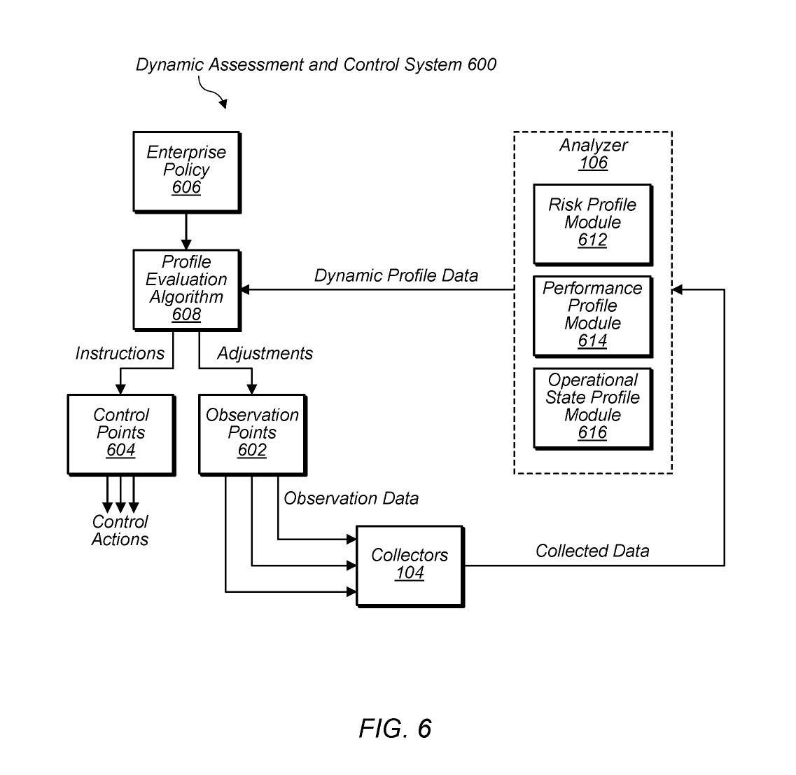

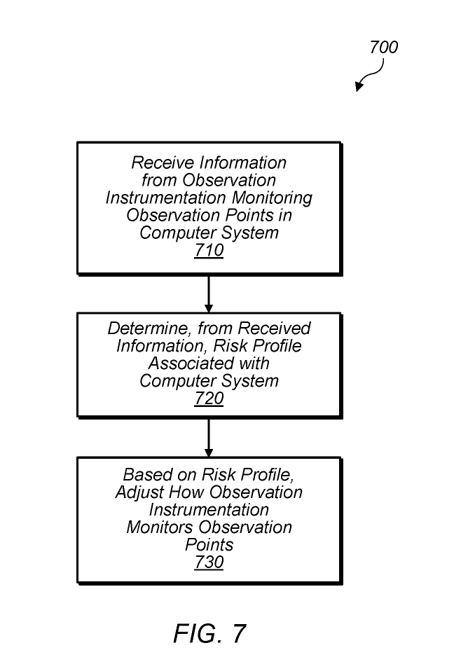

The techniques described herein with respect to dynamic analysis and control may be performed for any suitable computer system. Accordingly, this computer system may be a single computing device, such as a mobile device, desktop computer, etc., which may collect and analyze observation data. This computer system may also be a computer network that includes multiple computing devices. Techniques described herein with respect to observation, analysis, and/or control may also be performed locally (e.g., at one or two computers in a computer network) or globally (e.g., across the entire network or large groups of computers within the network). As one example of a computer network, the present disclosure begins with a discussion of a computer network that uses observation data collected from network endpoint computers systems to supplement traditional network flow analysis in conjunction with FIGS. 1-5. Dynamic assessment of computer system activity is then presented below with respect to FIGS. 6 and 7.

As used herein, an “endpoint computer system” is a node associated with the network that can serve as the originating source node or terminating destination node of a network communication. This node may be associated with the network, for example, by being located within the network or by being coupled to the network from an external location via some connection (e.g., a virtual private network (VPN) connection). In some cases, an endpoint computer system is a cloud-based server. An endpoint computer system is distinguished from other network nodes that serve to switch, route, or transfer network traffic as it transits the network from an originating source node to a terminating destination node. In some cases, an “endpoint computer system” may be configured to act both as an endpoint node (or collection of endpoint nodes) and as a switching or routing node. This arrangement is common in virtualized networks or systems, in which a computing system may host multiple virtual machines with an interconnecting virtual network. This scenario is also possible, for example, in (non-hierarchical) mesh networks, where any node in the mesh may source, sink, transfer, switch, or route network traffic. Thus, a given physical network node may be configured to a single network role or to multiple roles, depending upon the network architecture and degree of virtualization. But as stated above, an “endpoint computer system” is one that can act as a source or destination node of a network communication.

In some instances, endpoint computer systems may include desktop computers, laptop computers, server computers, and mobile devices (e.g., phone or tablets) within the access or lowest network layer, and stand in contrast to computer systems that are located at higher layers within the network infrastructure, particularly the distribution and core layers. Many “endpoint computer systems” are configured to communicate with an associated network via a network interface, and further configured to support user interaction via human interface devices, including, but not limited to, a keyboard, and some means of pointing and selecting objects on a display of the endpoint computer system (e.g., mouse, touch screen display, etc.). Other “endpoint computer systems” are servers in the access or lowest network layer, such as those located within an entity's data center. Endpoint computer systems do not, for example, encompass computing devices located at higher layers of the network hierarchy that are not configured to serve as the source or destination node for a network communication, including layers configured to route network traffic between different broadcast domains.

An “endpoint computer system” may also include apparatuses within the so-called Internet of Things (IoT), including physical objects such as devices, vehicles, buildings, and other items that are embedded within electronics, software, sensors, and network connectivity that enable these objects to collect and exchange data. Within an enterprise computing environment, an IoT could include almost any conceivable device, including printers, scanners, desk phones, electronic door locks, badge readers, security cameras, smart buildings, industrial control systems, etc.

Turning now to FIG. 1, a block diagram is shown of a system 100 that implements an endpoint information collection architecture. System 100 includes a network 110, which is coupled to various network flow devices—namely, flow collectors 104A-B and flow analyzer 106. Network 110 is also coupled to several representative endpoint computer systems 120. Shown are desktop computer 120A, laptop computer 120B, mobile phone 120C, and data center server computer 120D. These are representative of numerous types of endpoint computer systems that may be connected to network 110.

Information may therefore be collected regarding computing activity on endpoint computer systems in a manner that does not rely on the network infrastructure. This capability allows collection not only of traditional data from OSI layers 3 and 4, such as source and destination IP addresses and ports, but also provides additional valuable information associated with OSI layers 4-7, including, for example, the executable responsible for a particular network socket, an associated cryptographic hash (e.g., MD5, SHA1, SHA2, SHA 256, etc.), process and file path of the executable, the user responsible for launching the executable, and whether the executable is being run in the foreground or background of the endpoint. (A “foreground” process is one that is actively selected by the user, as opposed to a “background” process associated with a minimized window or other system activity.) This paradigm thus provides “last-mile” visibility to provide additional information about network flows. As used herein, the phrase “network flow” is to be broadly understood according to its ordinary meaning in the art, which includes, at least in some embodiments, a unidirectional sequence of packets being transmitted within a network. In various embodiments, the sequence of packets may share certain characteristics (e.g., same source and destination IP addresses). Similarly, “network flow data” is to be understood according to its ordinary meaning in the art, which includes information about a network flow within a network.

Information collected at endpoints may then be sent to devices in the network (or external to the network such as cloud-based devices), such as network flow analyzers, that use this information to supplement flow information collected within the network infrastructure. For example, if a network administrator is interested in a particular network flow, he or she may choose to review additional endpoint information to obtain a more complete picture of the security situation. In various embodiments, this information may be packaged in a standard network flow data record format. For example, endpoint information may be included in a record that combines standard IANA-defined fields with custom extended fields formatted as IPFIX information elements. As used herein, the phrase “network flow data record” refers to data that is organized in a format that permits the transmission of data regarding a particular network flow, such as from a flow collector to a flow analyzer within a network. Information formatted according to an IPFIX standard is one example of a network flow data record.

Collecting endpoint information and using it to supplement network flow analysis has a number of potential benefits. Because a richer data set providing additional relevant context is being utilized, incidents of false positives for potential network security incidents may be reduced. Additionally, the data provided to analysts, security operations center (SOC) personnel and incident handlers will allow them to quickly investigate the nature of the network traffic and determine if it is malicious or benign. Used in conjunction with network-based alerts (firewall, Intrusion Detection System/Intrusion Prevention (IDS/IPS) systems, web proxies and gateways), the approach disclosed herein may dramatically decrease the amount of time it takes to work through a security incident. This approach also opens network flow analysis to a part of the network (access layer) previously thought too expensive to include. Still further, providing insight into lateral data movement within the data center may allow administrators to more quickly prevent the spread of a cyber-attack.

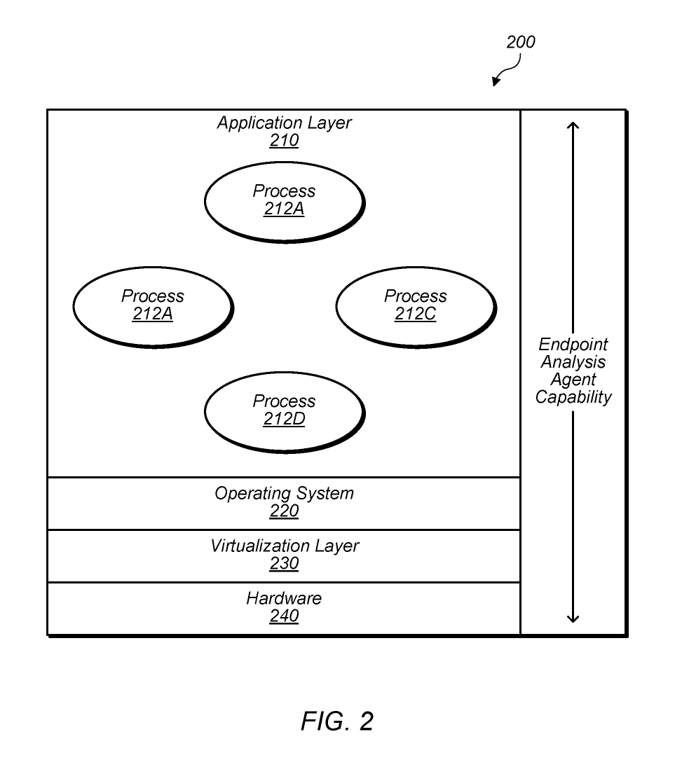

Accordingly, an endpoint computer system according to the present disclosure may be configured to implement an “endpoint analysis agent,” which, as described in more detail with reference to FIG. 2, may refer to hardware, or software executing on hardware. The endpoint computer system is configured to couple to a network that includes a network flow analyzer. The endpoint computer system may further be configured to collect information regarding computing activity internal to the endpoint computer system, and include, in one or more network flow data records, endpoint data based on the collected information. As used herein, “internal” activity refers to activity of the endpoint computer system that is not visible from the network to which the endpoint computer system is coupled. Still further, the endpoint computer system may be configured to transmit the one or more network flow data records within the network such that they are received by the network flow analyzer.

The network flow analyzer may be configured to receive the endpoint data and to receive network flow data from one or more flow collectors within the network. The network flow analyzer may be further configured to perform an analysis of the network based on the network flow data received from the one or more flow collectors. The analysis may further be based on the endpoint data included in the one or more network flow data records transmitted by the endpoint computer system.

As used herein, a “network flow analyzer” is a computing device within a network that is configured to collect network flow data from multiple flow collectors within a network, and to perform network security analysis based on the collected network flow data. (The term “analyzer” is used below to more generally refer to a computing device associated with a computer system that is configured to analyze data about the computer system from multiple collectors.) A network flow analyzer according to the present disclosure may also base its network security analysis on information received from endpoint computer systems. A network flow analyzer refers to a physical device, which may perform the network security analysis using hardware or software running on hardware. A network flow analyzer may of course perform additional functions in various embodiments and is not merely limited to performing a network security analysis. Similarly, as used herein, a “flow collector” is a computing device within a network that is configured to collect information about network activity. (The term “collector” is used below to more generally refer to a computing device associated with a computer system that is configured to collect data about the computer system, which may include network flow data collected from the system.) In various embodiments, a flow collector is configured to cause the collected information to be transmitted to a network flow analyzer. As with the network flow analyzer, a flow collector is a physical device, and may collect network flow information using only hardware or software running on hardware. A flow collector may also perform other functions. In various embodiments, a flow collector may receive network flow data from multiple observation points within the network. Further, the generic term “network flow device” is used herein to include any device within a network (i.e., not an endpoint computer system) that is configured to observe or analyze network flows. Flow collectors and network flow analyzers are examples of network flow devices.

In some embodiments, the endpoint analysis agent may include instructions embodied on a non-transitory computer-readable medium that are executable by an endpoint computer system to cause operations such as those described above. As used herein, instructions that are “executable” by a computing device means that, if executed, these instructions will cause the computing device to perform the recited operations. This phrase is also intended to cover the scenario in which a computing device includes the executable instructions, but is not currently configured to execute the instructions. For example, if the recited instructions are part of a software application that is currently disabled, these instructions are nevertheless still “executable” to perform certain operations, the same as if these instructions were part of currently enabled functionality. In other words, the question whether instructions are “executable” on a computing device to perform certain tasks is based on whether those instructions reside on a non-transitory computer-readable medium and not whether those instructions are currently enabled on the computing device (e.g., by some software setting).

An endpoint analysis agent may be implemented on an endpoint computer system in a variety of ways, as illustrated by FIG. 2. That figure depicts a diagram 200 for an exemplary endpoint computer system 120, which is shown as potentially having various layers: application layer 210, operating system layer 220, virtualization layer 230, and hardware layer 240. As shown, application layer includes representative processes 212A-D.

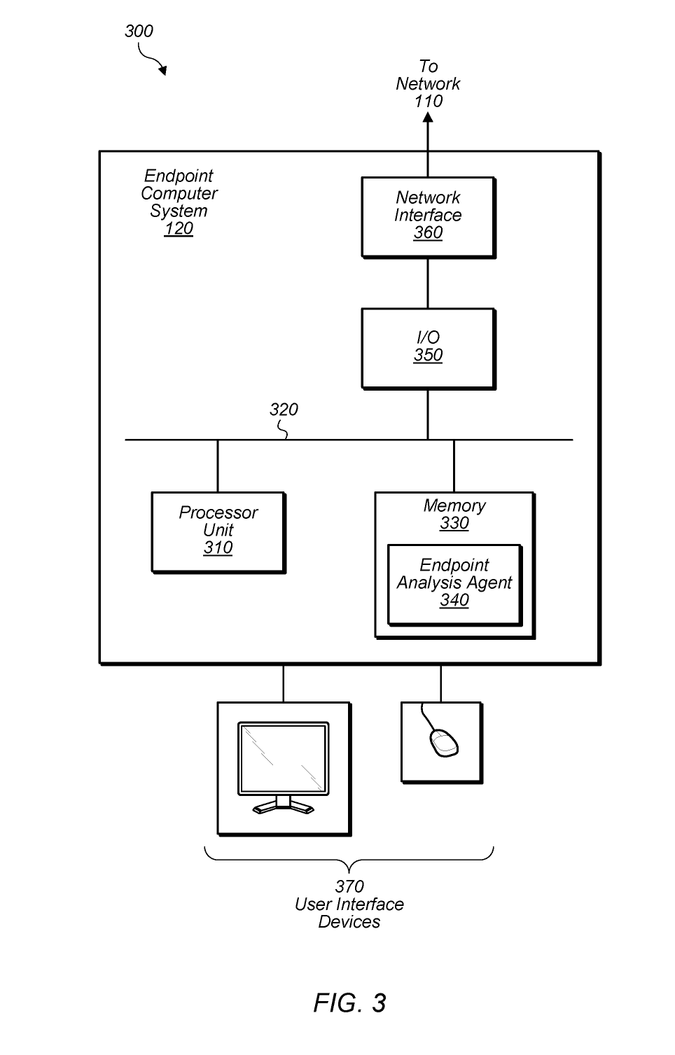

In the depicted configuration, endpoint computer system 120 includes a hardware layer 240, which includes the actual underlying hardware of the system that supports process execution (e.g., processors, memory), and is discussed further with reference to FIG. 3. Endpoint computer system 120 further includes an operating system layer 220 that supports multiple system and application processes 212, including, in some embodiments, an endpoint analysis agent process. Some systems 120 may further include a virtualization layer 230 situated between operating system 220 and hardware 240. Virtualization layer 230 may, in various embodiments, include a hypervisor, a virtual machine manager, or some other type of virtual container.

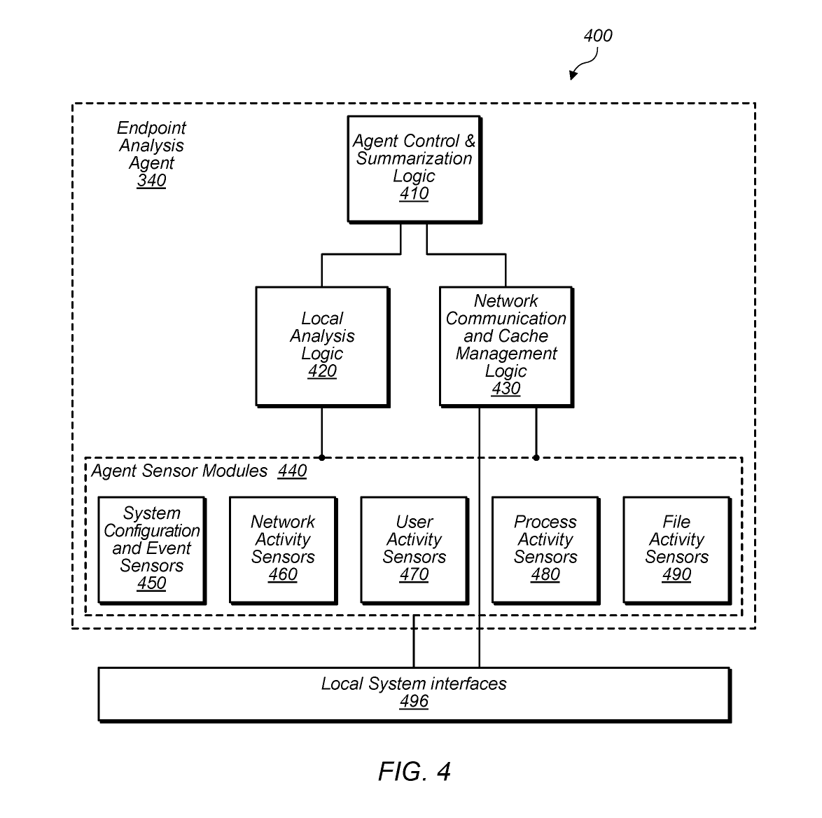

As indicated in FIG. 2, the agent capability may be implemented at any level or levels in the diagram, including as an application process 212 above operating system 220 in application layer 210, as part of operating system 220 (e.g., a kernel or driver component), as part of virtualization layer 230, or even as part of the system hardware 240. (Note that system hardware 240 or operating system layer 220 may be virtualized by virtualization layer 230.) Physical or virtual hardware access may be mediated by operating system layer 220 using system-provided application programming interfaces (APIs). The endpoint analysis agent may interact with operating system layer 220 via these APIs to instrument and track a variety of information, such as as that discussed in detail below with reference to FIG. 4.

Endpoint analysis agent may exist as part of the operating system layer 220, as an installed driver within operating system layer 220, as a module within virtualization layer 230, or even as part of the underlying hardware 240. The agent capability may exploit any combination of layers, each with their own specific instrumentation interfaces as incorporated in their design. Lower level instrumentation, such as in the hardware or virtualization layer, may provide visibility to endpoint operation aspects that are hidden at higher levels. The reverse may also hold true, where higher level software abstractions are not as visible at lower instrumentation layers. Choice of agent capability layering is thus an implementation choice. Note that in a system such as system 100 depicted in FIG. 1, the endpoint analysis agent capability may be implemented variously in different ones of endpoint computer systems 120. It may make sense to implement the agent capability differently in a data center server as compared to a mobile phone, for example.

In some cases, the endpoint analysis agent may implement discontinuous monitoring of an endpoint, such that the agent is active or inactive at different times. For example, the endpoint analysis agent may be “dissolvable” such that it is not continuously installed or enabled. A dissolvable agent may install itself in order to collect information from an endpoint, and once the information is collected (e.g., a scan is performed), the agent will remove itself from the endpoint.

In some enterprise environments, it is generally disfavored to install and maintain agent software of any kind on endpoints. In such environments, a remote endpoint analysis agent may be located on another system, typically a server, that periodically polls the endpoint to collect monitoring information. Whereas a local agent using operating system-provided APIs to collect this information, if these calls are exposed remotely, e.g., via remote procedure calls (RPC), then the agent could reside on a remote system and use the RPC mechanism to make the API calls. In many cases, there are additional delays and network operation overhead to implement this paradigm continuously, so it is not always practical to remotely monitor endpoints continuously as it would be locally. Often, such a remote arrangement would be periodic or intermittent. For very inexpensive or primitive endpoints (as in IoT settings), this may be the only agent option. In some embodiments, the remote agent paradigm may be implemented in WINDOWS computer using Remote Windows Management Instrumentation (WMI).

More generally, the endpoint analysis agent can be said to be virtualized (i.e., not physically present on the endpoint), and operate remotely over the network. In sum, endpoint analysis agent may be implemented in several different ways with respect to an endpoint computer system.

Turning now to FIG. 3, a block diagram of a system 300 is shown that includes an exemplary endpoint computer system. In this particular configuration, endpoint analysis agent 340 is implemented in software—for example, according to one of the arrangements described above with reference to FIG. 2. But as previously noted, in other embodiments endpoint analysis agent may be implemented differently in other systems, such as in a hardware module.

As shown, system 300 includes endpoint computer system 120, which is coupled to network 110 and, in some embodiments, user interface devices 370. In the illustrated embodiment, endpoint computer system 120 includes a processor unit 310 that is coupled to a system memory 330 and I/O interfaces(s) 350 via an interconnect 320 (e.g., a system bus or chipset interface). I/O interface(s) 350 is coupled to one or more I/O devices, only one of which, network interface 360, is depicted in FIG. 3. Endpoint computer system 120 may be any of various types of devices within the definition of this term provided above, including, but not limited to, an access layer server system, personal computer system, desktop computer, laptop or notebook computer, data center computer system, tablet computer, handheld computer, workstation, a consumer device such as a mobile phone, music player, or personal data assistant (PDA), an embedded system, etc. Although a single system 300 is shown in FIG. 3 for convenience, system 300 may also be implemented as two or more computer systems operating together.

Processor unit 310 is a circuit that may include one or more processors or processing elements. In various embodiments of system 300, multiple instances of processor unit 310 may be coupled to interconnect 320. In various embodiments, processor unit 310 (or each processing element within 310) may contain a cache or other form of on-board memory. In the depicted embodiment, endpoint analysis agent 340 described above is executable by processor unit 310 at one or more of the various software layers described with reference to FIG. 2.

System memory 330 is usable to store program instructions executable by processor unit 310 to cause system 300 to perform various operations described herein. System memory is also usable to store data for access by processor unit 310. System memory 330 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 300 is not limited to primary storage such as memory 330. Rather, computer system 300 may also include other forms of storage such as cache memory in processor unit 310 and secondary storage on I/O Devices 350 (e.g., a hard drive, storage array, etc.). In some embodiments, these other forms of storage may also store program instructions executable by processor unit 310 to perform operations described herein.

I/O interfaces 350 may be any of various types of interfaces configured to couple to and communicate with other devices, according to various embodiments. In one embodiment, I/O interface 350 is a bridge chip (e.g., Southbridge) from a front-side bus to one or more back-side buses. I/O interfaces 350 may be coupled to one or more I/O devices via one or more corresponding buses or other interfaces. Examples of I/O devices include storage devices (hard drive, optical drive, removable flash drive, storage array, SAN, or their associated controller), network interface devices (e.g., to a local or wide-area network), or other devices (e.g., graphics, user interface devices, etc.). In the illustrated embodiment, computer system 300 is coupled to network 110 via a network interface circuit 360 (e.g., configured to communicate over WiFi, Bluetooth, Ethernet, etc.).

Turning now to FIG. 4, a block diagram is shown of a system 400 that includes an exemplary endpoint analysis agent 340 and local system interfaces 496. The representation of endpoint analysis agent 340 depicted in FIG. 4 is a logical one, with various modules and sensors depicted as distinct entities for ease of explanation. In various embodiments, these logical elements may be implemented differently (e.g., with different divisions between sensor modules 440) in other embodiments.

Local system interfaces 496 depicted in FIG. 4 refers to any hardware or software resource accessible by agent sensor modules 440. For example, local system interfaces 496 may include network interface 360 that is coupleable to a network such as network 110. Network interface 360 may include hardware and software elements in various embodiments. Interfaces 496 may also include various operating system-exposed application programming interfaces (APIs), which may allow various ones of agent sensor modules 440 to collect information about computing activity on an endpoint computer system 120. For example, an operating system may provide an API that returns to a querying process a list of active processes on system 120. In short, local system interfaces 496 represents any resources accessible by endpoint analysis agent 340 and its submodules.

Agent sensor modules 440 refer to computer program instructions that are executable to collect information regarding endpoint computer system 120, and particularly information relating to computing activity within system 120 that is not visible from network 110. The various depicted modules, 450, 460, 470, 480, and 490, are shown separately for ease of explanation, but can be combined in any suitable manner into a greater or fewer number of modules.

System event and configuration sensors 450 refer to computer program instructions that are executable to collect information regarding the configuration of endpoint computer system 120 or events that may occur on such a system. In various embodiments, sensors 450 may determine system identity information, such as the hostname, IP address, MAC address, and serial number of system 120. Any other suitable type of system identity information may also be determined, such as an inventory tracking number for system 120, or other enterprise-assigned tags or attributes. Additionally, sensors 450 may further determine location information for system 120—for example, geographic locale, the building in which the system is located, what portion of a network system 120 is logged into, etc. Sensors 450 may further determine the hardware configuration of system 120—that is, the peripherals, storage devices, network interfaces, or other hardware resources of the system. Sensors 450 may also be operable to determine the state of a registry or other configuration file of system 120.

Sensors 450 may further be operable to collect system compliance information. The nature of this information is well understood in the art, and encompasses a variety of information, including, but not limited to, operating system version installed, patches installed (e.g., OS, driver, and application patches), encryption status (e.g., whether data is fully encrypted as may be required in some systems to prevent data theft should the endpoint fall into the wrong hands), known vulnerabilities, the presence or absence of so-called mandated agents (e.g., programs designed for security, management, backup, etc.), and whether certain mandated configuration settings have been applied.

Still further, sensors 450 may also include event sensors. These sensors may record, for example, the occurrence of various software events and/or faults, particularly those that are not detectable with remaining sensors 460, 470, 480, or 490. For example, MICROSOFT WINDOWS operating systems support extensive logging and auditing features that may not be entirely exposed through APIs. Thus, event sensors 450 may be used to access such information.

Network activity sensors 460, as their name suggests, refer to computer program instructions that are executable to collect information relating to network activity. For example, sensors 460 may collect source and destination network address and port information for active network connections—such information may be usable in matching endpoint computing activity with network-observed flow activity. Sensors 460 may also collect information about the volume of network traffic including, for example, an amount of data sent or received on each connection, either in total for that connection or broken down by time period. Similarly, for each active network connection of endpoint computer system 120, sensors 460 may identify each process that corresponds to one of the connections (i.e., the “communicating process”), as well as its image file path and file name, cryptographic hash value and image metadata, and process command line.

Collecting this information may, in some instances, require multiple API calls. For example, image metadata and cryptographic hash value information may be collected from the file system, while network contact information such as addresses and ports may be collected from the network system.

Sensors 460 are not limited to observing network activity relating to active connections, however. For example, sensors 460 may detect failed Domain Name Service (DNS) lookup requests, which may, in some instances, be indicative of malware attempts using domain generation algorithms. Similarly, sensors 460 may also detect other types of failed connection attempts, which might indicate attempts by endpoint computer system 120 to passively scan the network or manipulate Address Resolution Protocol (ARP) requests—for example, to facilitate man-in-the-middle attacks or ARP cache poisoning.

User activity sensors 470 include computer program instructions that are executable to collect information relating to users of endpoint computer system 120. For example, in various embodiments, sensors 470 may indicate what users are currently logged in to endpoint computer system 120 and whether each login is local or remote. Sensors 470 may further indicate associated account attribution for observed network activity such as identifying which logged-in users or accounts correspond to particular observed network activity. (Note that, as a general matter, certain types of information could arguably fit into multiples ones of the disclosed sensors; this functionality could also be handled by network activity sensors 460, for example.)

Sensors 470 may also collect information about the activities of users. For example, sensors 470 may collect information relating to user activity or inactivity, such as whether there is any input being supplied by the user (e.g., through user interface devices 370). Sensors 470 may also determine what user process are in the foreground (e.g., the identity of the process associated with a currently active window, such as a word processing program to which the user is currently inputting text, as compared to other processes running in the background). Additionally, sensors 470 may keep a list of recent foreground processes. A foreground process may be identified, in some embodiments, at the level of a particular tab of a browser program.

Process activity sensors 480 include computer program instructions that are executable to collect information identifying the contexts in which processes execute on endpoint computer system 120. Most basically, sensors 480 may determine an inventory of current endpoint system processes. Additionally, sensors 480 may determine the activity profiles of these processes, as well as indication of their consumption of system resources. Historical information may also be collected, such as process creation and termination times. Still further, sensors 480 may collect process hierarchy information, such as parent and child process of a given process (particularly a process involved with network activity—a communicating process). The means of process creation may also be collected—for example, whether a process such as a communicating process is likely to be user-initiated (as well as what particular account or user initiated creation) as opposed to automatically started in the background. Finally, various types of process identifying characteristics may be collected, including version metadata, cryptographic hash value, file path, and so on. This collected contextual information may be useful to a network flow analyzer attempting to correlate network activity with endpoint activity such as identifying a particular process from which network activity originated.

Finally, file activity sensors 490 are computer program instructions executable to collect information relating to files on or accessible by endpoint computer system 120. For example, sensors 490 may indicate what files are being accessed, the frequency of access, the identity of the process or user accessing the file, and information about the volume of network traffic associated with accessing files. This information, along with various other types of information collected by sensors 440, may be useful to network flow analyzer 106 in matching network activity with endpoint activity. For example, network-observed activity may be correlated with a particular process, user, and file based on information collected by sensors 480, 470, and 490, respectively.

Collectively, agent summarization and control logic 410, local analysis logic 420, and network communication and cache logic 430 take the information collected by sensors 440, perform an optional local analysis, and determine the format, granularity, and size of the data, which may be sent to network 110 via local system interfaces 496 and/or cached for later use.

In various embodiments, the information collected by sensors 440 may be initially processed by computer program instructions in local analysis logic 420. This processing may take the form of lightweight pre-processing relative to further processing that may occur at network flow analyzer 106. For example, local analysis logic 420 may be programmed to look for certain sequences of operations, such as failed DNS look ups. Similarly, logic 420 may look for so-called indicators of compromise (e.g., signatures of known malware or attacks) or for common applications communicating over unusual port numbers. In this manner, local analysis logic 420 may provide a preliminary risk assessment for activity relating to endpoint computer system 120. This information may be used by agent control and summarization logic 410 to determine what data is to be sent and in what format. In some embodiments, multiple ones of endpoint computer systems 120 in a network may each perform a local analysis, thus lightening the processing load on network flow analyzer 106.

Agent summarization and control logic 410 includes computer program instructions that are executable to exercise overall control over endpoint analysis agent. Logic 410, in one embodiment, is operable to determine what data to send and in what format. For example, information provided by local analysis logic 420 may indicate how important currently collected information is—for example, how likely is it that the collected information corresponds to a security threat. This may be useful in determining whether or not to send certain data to network 110 for further processing. Additionally, logic 410 may also be operable to determine the format used to send data to network 110. As will be described below, certain data reduction operations may be performed on collected data, so that not all collected data is sent over the network. Instead, data corresponding to particular times may be transmitted. Alternately, compression may be performed on collected data. Still further, collected data may be abstracted or summarized to reduce level of detail and time granularity.

In one embodiment, network communication and cache management logic 430 is responsible for communicating data to network 110 in the chosen format via local system interfaces 496. Logic 430 may also be responsible for performing the previously mentioned data reduction operations (this may also be performed by logic 410 in other embodiments). Finally, as its name suggests, logic 430 is also responsible for caching data, such as during periods when an endpoint computer system 120 is not in contact with to network 110, such as when system 120 loses connectivity, when network bandwidth is too expensive (e.g., a satellite link), or when it is determined that network activity may exhaust too much battery power (e.g., as in the case of a mobile device).

In some embodiments, the data collected by sensor modules 440 may be assembled (e.g., by control logic 410 and/or cache logic 430) into network flow data records that are far more informative than traditional network flow data, which commonly does little more than identify a network address of an endpoint computer system 120. Instead, in various embodiments, endpoint analysis agent includes endpoint activity information in extended network flow data records. The Internet Engineering Task Force's IP Information Flow Export (IETF's IPFIX) standards, for example, provide an extensible flow data record format. Use of such a format allows information to be conveyed in a format similar to that currently in use within the industry. But by exploiting this flow data extensibility, additional endpoint security context may be provided, enabling far more specific analysis by the network flow analyzers to more accurately identify and prioritize network security threats. The present disclosure is not limited, of course, to use of the IPFIX standards. Instead, flow data may be conveyed using any other extensible formats or proprietary formats used by commercial network security infrastructure providers. Accordingly, sensor modules 440 may assemble any suitable data records associated with user activity, file access, registry operations, performance characteristics, device attach/detach, location data, log/audit events, etc.; these records may also be formatted in accordance with other formats such as Protobuf, JSON, XML, etc.

Once properly formatted, network logic 430 is configured to transmit the network flow data records to one or more network flow devices in network 110. These transmissions may either be unicast (i.e., sent to one network flow device in network 110) or multicast (i.e., sent to multiple network flow devices). Note that network flow analyzers that ultimately will be processing the flow data records may need to be modified to recognize the extended flow data records and correlate this additional data with network-observed flow data.

As mentioned, cache logic 430 is operable to cache information collected by sensors 440. In some instances, cache logic 430 may be used to implement temporary storage and buffering of the collected information, particularly while endpoint analysis agent 340 is determining when and at what level of detail to forward this information over the network to network flow data analyzers and flow collectors. Cache logic 430 may also serve to retain collected information over periods of loss of network contact between agent 340 and its associated data analyzers or collectors. Alternatively, cache logic 430 may be operable to retain data for a configurable holding period. During this period, analyzers may request additional data detail from cache logic 430. For example, cache logic 430 may send summarized data to network flow analyzer 106. Flow analyzer 106, upon analyzing this data, may determine that additional data detail is needed to complete its analysis. In some embodiments, if a request for this additional detail is made during the holding period, cache logic 430 can supply this information.

The ability of cache logic 430 to retain collected information is particularly useful for mobile endpoints, which are configured to decouple from networks, such that they are not in communication with network flow devices. Cache logic 430 serves to hold data until a connection is re-established. In some embodiments, data can be forwarded to the network via cloud servers for subsequent secure relay to network flow devices, such as in an enterprise network. By continually monitoring the activity of endpoint computer systems 120 whether or not they are connected to the network, certain blind spots that previously existed from a network administrator viewpoint are eliminated. This solution allows application, for example, of an enterprise policy to a device that is decoupled from the enterprise network. (A decoupled device may actually need more intensive monitoring since the endpoint is not behind enterprise perimeter defenses.)

Because sensor modules 440 may collect large amounts of data, it may be desirable to reduce the amount of data transmitted to network flow devices for analysis. This may be accomplished with various types of data reduction operations. For example, data may be summarized. As one example, unique network targets contacted over a specified time period may be reported, such as daily or since the last boot. This represents a reduction of data as compared to reporting repetitive contacts to the same network target. This approach avoids the high overhead of always supplying full data flow detail across all monitored endpoints, when only a small fraction of network activity justifies this detailed level of examination.

Data may be summarized on additional various criteria, including novelty, importance, or risk. Still further, data may be reduced by various other means, including compression techniques, or only reporting selected or random data. Cache logic 430 may also selectively abstract context and attribution data, either through a static configuration or using dynamic risk assessment to determine the appropriate level of data detail. Dynamic risk assessment tracks the current risk level associated with the system, user, process, and network activity, for example based upon how usual versus unusual the activity pattern appears. Depending upon the sophistication of the risk assessment algorithm, this could be as simple as a green/yellow/orange/red risk categorization or as complex as a multi-dimensional risk quantification vector.

As described above, endpoint analysis agent 340 is operable to collect endpoint information, package that information (or a subset of that information) in one or more network flow data records, and send those records to network 110, where it may be received either by network flow analyzer 106, or by network flow collector 104, where it may be ultimately forwarded to analyzer 106.

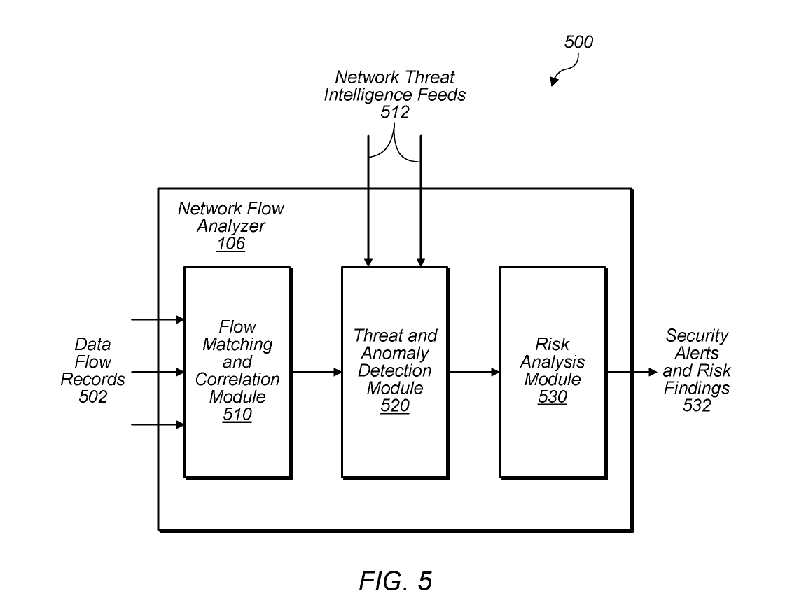

Turning now to FIG. 5, a block diagram of a system 500 that includes network flow analyzer 106 is shown. As depicted, network flow analyzer 106 includes flow matching module 510, threat and anomaly detection module 520, and risk analysis module 530. These modules may be implemented either in hardware, software, or a combination thereof.

Flow matching module 510, in various embodiments, receives data flow records 502. Some of these records may include traditional (i.e., non-endpoint) flow information, while others may include endpoint information such as that produced by endpoint analysis agent 340 as described above. Some records may include a combination of both types of flow information.

Module 510 may include computer program instructions executable to match, or correlate, information about a flow observed within the network infrastructure with endpoint information that corresponds to that flow. Accordingly, any or all of the endpoint data collected by endpoint analysis agent 340 (e.g., process id, foreground/background process, executable file name and path, etc.) may be associated with a corresponding flow within the infrastructure of network 110. In some embodiments, this association may take the form of including additional information within a data structure maintained by network flow analyzer 106 for a particular network flow. In other embodiments, the endpoint data may be linked to a data structure for a particular network flow.

As used herein, “matching” endpoint information with network flow data is intended to broadly cover any process in which endpoint information is used to supplement network-observed flow data. Endpoint information about a particular process executing on an endpoint computer system may be used to augment information about an associated network flow. For example, information about a particular network flow (received from a flow collector) can be supplemented with endpoint information, such as the identity of the process on an endpoint computer system that initiated the particular network flow.

With network and endpoint information associated in some fashion, the consolidated information may be forwarded to threat and anomaly detection module 520. In some embodiments, module 520 includes computer program instructions that are executable to determine whether network activity should be classified as potential threat or anomaly. As shown, module 520, in some embodiments, may receive network threat intelligence feeds 512. Feeds 512 refer to any third-party data that provides information regarding known cyber-threats. Module 520 then uses a set of rules or heuristics, optionally in conjunction with feeds 512, to make a threat assessment determination.

Consider an example in which a port 80 connection is being made to Internet destination 23.64.171.27. This may be the extent of information discernible by traditional network-based flow collection tools. Given this information, a network analyst may dismiss this alert as a false positive. But because endpoint information has been collected by endpoint analysis agent 340 and sent to network flow analyzer 106, the port 80 connection may be correlated by flow matching module 510 with information indicating that the connection was not initiated by a web browser, but rather through a task automation program such as a WINDOWS POWERSHELL. Additionally, module 510 may also determine that the connection was initiated by the “System” account and not a logged-in user. Additional information may also be determined, such as what actions were taken before and after the connection (malicious processes tend to perform actions before and after connections that constitute a recognizable attack pattern), as well as a history of endpoint process activity. Such information, when coupled with the network-observed activity, may be used by module 520 in more accurately determining whether network activity constitutes a security threat.

The possibilities for exploiting the disclosed endpoint collection paradigm are numerous. For example, in evaluating anomalously large network traffic flows, endpoint information can be used to determine, for example, whether this is a normal backup operation or a suspect data staging or exfiltration. Endpoint information can help in this determination by knowing the originating process context (e.g., the process identifier of the process creating the activity, process hierarchy information of the process, identifying characteristics of the process, etc. as noted above) and associated account attribution (e.g., the account or user to which the network activity can be attributed). Similarly, a large traffic flow may be traced to downloads by an employee recently separated from employment. Unusual HTTP or HTTPS traffic may also be evaluated, such as by determining whether it originates from a foreground browser process, as opposed, for example, to a background non-browser process. Still further, anomalous network traffic in terms of flow amounts, flow times, or network targets can be resolved by knowing if it is user-initiated traffic versus background traffic, as well as which process and account is associated with the flow. The same also holds true for an anomalous number of network connections or connection attempts. Correlated network and endpoint information may also help distinguish insider attacks from external attacks, for example by determining if the suspect activity is user-initiated versus autonomous, and whether the user login is local (user physically present, which would point to an inside attack) versus remote (potentially compromised user credentials may be employed by external attackers).

Threats and anomalies determined by module 520 may then be passed to risk analysis module 530, which, in some embodiments, includes computer program instructions executable to assign a risk level (e.g., high, medium, low) to these threats and anomalies. Some activity classified as a threat or anomaly may be determined by module 530 to not be a threat at all. Note that in some embodiments, modules 520 and 530 may be combined into a single module.

As shown, module 530, in some embodiments, is operable to output security alerts and risk findings 532. This information may be output, in some embodiments, via a graphical user interface that allows a network security administrator to view, for a particular identified threat or anomaly, endpoint information in addition to the network-observed activity. Such an interface may allow an administrator to more quickly and accurately assess network security risks.

Turning now to FIG. 6, a block diagram of a system 600 for dynamically assessing computer system activity is depicted. As noted above, activity information for a computer system, such as information collected by endpoint computer systems 120 as well as other devices in network 110, may be collected in a static manner. System 600, however, may be configured to continually assess this collected information and dynamically adjust the manner in which subsequent information is collected and/or adjust how aggressive it is when taking various control actions responsive to what is being assessed. These adjusts may also be made locally (e.g., for a single computer in the system) or globally (e.g., across the entire system). In the illustrated embodiment, system 600 includes observation points 602, control points 604, an enterprise policy 606, profile evaluation algorithm 608, collectors 104, and analyzer 106. As shown, analyzer 106 includes a risk profile module 612, performance profile module 614, and operation state profile module 616. In some embodiments, system 600 may be implemented differently than shown. Accordingly, although FIG. 6 depicts flow collectors 104 and flow analyzer 106 described above with respect to FIGS. 1-5, system 600 may include collectors and an analyzer that implement functionality different from what was described above with respect to elements 104 and 106 such as not implementing network flow collection and analysis in some embodiments.

Observation points 602 correspond to any place in a computer system where an activity can be observable by observation instrumentation, which may be implemented in hardware and/or software, in order to learn about operation of the system and its components. As discussed above and below, these activities may be useful in determining security risks for a system, determining performance of system components, determining the operation states of system components, etc. In some embodiments, observation points 602 may reside at endpoint computer systems 120 and be observed by observation instrumentation such as an endpoint analysis agent 340 discussed above. In some embodiments, observation points 602 may reside at other system components such as switches, gateways, routers, etc. In some instances, the observation instrumentation (e.g., endpoint computer systems 120, agents 340, switches, etc.) monitoring a particular activity may be located where the activity occurs or located outside the device where the activity occurs. As shown in FIG. 6, observation data collected from observation points 602 may be provided to collectors 104, which gather observation data for analysis and may optionally cache and summarize collected data before forwarding it to analyzer 106 discussed above. In various embodiments, observation instrumentation monitoring a particular point 602 may continually produce observed data or to buffer the data and periodically send it to collectors 104.

Control points 604 correspond to any location where an action to control a computer system or one or more system components can be taken. As with observation points 602, control points 604 may reside at endpoint computer systems 120 or other network components such as switches, gateways, routers, etc. In some instances, the control instrumentation that effectuates a particular control action may be located at the device where a control point 604 resides or may be located externally to the device. Various examples of control actions are discussed in greater detail below.

Enterprise policy 606 is a set of criteria (e.g., rules) that define how a computer system is to be monitored at observation points 602 and/or define the control actions to been taken at control points 604 when particular events occur. As the name suggests, policy 606 may be tailored to the particular needs of a given enterprise based on the enterprise's risk sensitivity, asset valuations, overhead tolerance, service level objectives, and monitoring requirements. In various embodiments, policy 606 specifies criteria in terms of thresholds corresponding to the desired extent, degree, or granularity of observation point monitoring and thresholds for when determined control actions are to be taken.

In some embodiments, thresholds for monitoring may be specified in terms of risk, performance, or operational state in order to increase or decrease the monitoring activity levels at observation point 602. For example, policy 606 may identify a first frequency at which an observation point 602 is to be monitored (e.g., every minute for a particular metric) when a component associated with that observation point is determined to have a risk assessment score that exceeds a threshold amount, and identify a second threshold (e.g., every five minutes) when that threshold has not been satisfied. Other potential thresholds may be defined, for example, with respect to the buffering timespan for maintaining observation data, types or amounts of observation data to retain (as well as where—e.g., locally at points 602 versus forwarded to collectors 104), how much analysis to perform locally at the observation points 602 and control points 604 versus remotely by analyzer 106, etc. In some embodiments, policy 606 may vary criteria by observation point 602 or by a group of observation points 602, which may be grouped into organizational units based on an observed system or asset values. Policy 606 may also vary criteria by user or user group, or by contact type or contacted entities, or by risk factor, etc. In some embodiments, policy 606 may appropriately adjust for performance overhead tolerances so as not to unduly impact enterprise performance requirements or service delivery goals. In some embodiments, policy 606 may incorporate decision theoretic criteria (for example statistical divergence or information gain metrics) to help optimize the information value and communications efficiency of observed and summarized data.

In various embodiments, policy 606 may also define similar thresholds for taking appropriate control actions to maintain components within enterprise policy guidelines. For example, policy 606 may indicate that a particular component is to be isolated from the remainder of a computer system, such as an endpoint 120 of system 100, when it has a risk assessment score satisfying a specified threshold. Additional examples of particular actions to address or mitigate risk exposure may include process suspension or termination on endpoint computer systems 120, network restrictions and quarantine, user restrictions, priority adjustments, etc., or actions to address performance or operational issues. Policy 606 may also specify performance actions to be taken to manage performance and operational state actions to be taken to manage operational state of a system.

Profile evaluation algorithm 608 is operable to continuously evaluate dynamic profile data received from analyzer 106 against policy 606 in order to make adjustments to observation points 602 and take particular actions at control points 604. As used herein, the term “profile” refers to a collection of one or more scores determined for system components with respect to a particular topic. In the illustrated embodiment, algorithm 608 evaluates profile data with respect to dynamic risk profiles pertaining to the current risk exposure of one or more components, dynamic performance profiles pertaining to the current performance of one or more components, and dynamic operational state profiles pertaining to the current operation states of one or more components as will be discussed below. Through evaluation of this information and use of policy 606, algorithm 608 may be able to achieve a balance, for example, with respect to the quality of monitoring versus the overhead tradeoff for enterprise cyber systems and networks—thus allowing for monitoring in accordance with targeted performance levels and operational requirements. In various embodiments, program instructions executable to implement algorithm 608 are embodied on a non-transitory computer-readable medium and are executable by a computer system to cause operations described herein with respect to algorithm 608. In some embodiments, this computer system is the same physical device implementing flow analyzer 106; in other embodiments, this computer system may be a different computer system.

In various embodiments, observation instrumentation monitoring observation points 602 is programmable to control the extent, level, and/or detail of produced observation data. Accordingly, a computer system implementing algorithm 608 may adjust various ones of these programmable settings in order to allow appropriate policy-based tradeoffs to be made between observation detail and overhead levels, commensurate with evaluated risk, performance, and operational criteria applied to the profiles received from flow analyzer 106 as discussed below. Examples of programmable settings supported observation instrumentation may include settings for time periods of observation variability, continuous versus sampled observation, time granularity of sampling, etc.; settings for metadata collection versus full content capture (e.g., for files, network contacts, browser activity, etc.); settings for write/transmit versus read/receive accesses (e.g., all accesses or only changes, network flow metadata versus full packet capture, etc.); settings for user interface activity (e.g., capturing in-focus window versus capturing every window refresh, keystroke, and mouse click); settings for devices of interest such as removable storage devices, cameras, particular interfaces, etc.; settings for degree of measurement precision such as approximate versus exact data transfer sizes, approximate versus exact points in time, etc.; settings for degree of expected pattern departure such as providing additional detail or measurement frequency on unusual or anomalous observations or uncharacteristic departures from normality; settings for sessions of interest such as when certain users are logged in or when the login is remote, or when the system is operated outside the enterprise network or geo boundaries, etc.

In some embodiments, observation instrumentation is also programmable to adjust caching of collected information. As discussed above with respect to cache logic 430, information collected at observation points 602 may be stored in one or more caches, such as a cache at each endpoint computer system in some embodiments. In such an embodiment, settings may be programmed to instruct the observation instrumentation to control the local retention timespan (i.e., how long the collected information is stored by a cache) and amounts (i.e., how much of the collected information is stored). In some embodiments, observation instrumentation may also support settings for selecting which types and amounts of collected information are forwarded to collectors and analyzers, what criteria to set for forwarding requests (for example system idle vs busy), etc. and settings for local versus remote data analysis, including which types of analysis to perform locally versus remotely and on what processing schedules.

In various embodiments, control instrumentation associated with control points 604 is configured to receive instructions from the computer system implementing algorithm 608 in order to effectuate actions at control points 604. Performance of control actions may allow appropriate policy-based responses to be taken to dynamically maintain risk, performance, and operational state profiles within guidelines of policy 606 or to mitigate excursions from policy guidelines. In some embodiments, control actions taken at control points 604 may include cyber-security risk actions defined by policy 606 such as process suspension or termination actions; application restrictions to limit or control the usage or capabilities or privileges of particular enterprise applications; user restrictions to limit which users may operate the system or its applications or during what time periods or situations, etc.; network access restrictions to restrict or limit the network access capabilities of a system and/or user and/or application (e.g., adjusting an endpoint's security policy pertaining to its firewall settings, DNS enforcement, etc.); device usage restrictions to restrict or limit what devices may be attached to a system or network or in what manner they may be operated, etc.; taking a memory dump to view the contents of a computer system's memory; alerting or reporting actions; regulating the degree and extent of monitoring and control activity; regulating the degree of storage, archiving, and retention of observed data. In some embodiments, control actions taken at control points 604 include performance actions defined by policy 606 such as suspending or terminating lower priority processes to reduce resource contention; adjusting process priorities (e.g., to raise the priority of important or business critical processes or to reduce the priority of less important processes); rescheduling less time-critical processing activities (e.g., background scans or backup operations that drain resources); adjusting network priorities (e.g., using network quality of service capabilities); and regulating observation/control overheads that impact performance. In some embodiments, control actions at control points 604 include operational state actions defined by policy 606 such as allowing/restricting workload activity based upon user presence/absence or user identity and privilege level, date/time parameters, or other policy criteria; allowing/restricting network activity based upon policy criteria; allowing/restricting device attachment based upon policy criteria; and managing storage and other resource consumption of observation/control points. In various embodiments, actions taken at control points 604 may be performed globally or locally depending on what is being observed at observation points 602. For example, if observation instrumentation is consuming too much network bandwidth, a control action to reduce the amount of what is being reported may be taken at some observation points 602, but not all observation points 602 such as those associated with higher value assets or assets associated with a greater amount of potential risk.

As noted above, analyzer 106 is a computing device within a network that is configured to collect data about a computer system, such as network flow data discussed above, from multiple collectors 104 within a network, and to perform security analysis based on the collected data. In the illustrated embodiment, analyzer 106 performs this analysis via a risk profile module 612, performance profile module 614, and operational state profile module 616. In other embodiments, analyzer 106 may use more (or less modules); some or all of the analysis performed by modules 612-616 may also be performed elsewhere such as at flow collectors 104, observation points 602, and/or control points 604.

Risk profile module 612 is representative of program instructions executable to dynamically determine risk profiles that include one or more scores identifying assessed risks for a computer system or its components. Profiles determined by module 612 may be usable by algorithm 608 in conjunction with policy 606 to govern the extent, level, and detail of continuous observation point monitoring and/or determine control actions to be taken based upon analyzed risk factors. In some embodiments, module 612 may produce a respective risk profile for each monitored observation point 602 or may produce a risk profile for a group of points 602. In various embodiments, profiles produced by module 612 may be determined based on an assessment of multiple risk factors in order to obtain a holistic assessment of risk. For example, module 612 may assess user activity risk factors such as the presence or absence of user activity at an observation point 602; identity, reputation, and privilege level of the user or users at a point 602; whether a user is locally or remotely logged in to the observed system; a user's focused activities (observed foreground processes or other activities); login period versus normal user work times; and user work schedule pattern.

In some embodiments, module 612 also assesses system risk factors such as system hardware configuration, including active network interfaces, removable storage devices, etc.; system software configuration, including operating system version, patch levels, configuration options, etc.; system stress level, including processor, memory, storage, and network utilization levels, queue depths, etc.; conformity with enterprise security and management requirements, including mandated security and management agents, security settings, etc.; observed suspicion indicators, including indicators of compromise, aggregate exposed vulnerabilities, anomalous network activity, deviations from normal operating patterns; driver inventory; etc.

In some embodiments, module 612 may also assess application and/or application version (e.g., specific binary) risk factors for each active process such as application trust level based upon vendor reputation, patch level, known vulnerabilities, industry malware databases, length of history, specific version or version range, etc.; application prevalence across the enterprise observed system population, such as common versus rare, for the application or for specified application versions; likelihood of this application or application version being run on this system by this user in this time period; application resource consumption levels versus other applications or versus other instances of this application or application version, etc.; application data movement activity levels across the file system or network, versus other applications or versus other instances of this application or application version, etc.; and application threat level, including known attack history, potential for sensitive data exposure, appearance in threat intelligence reports, observed active exploits, etc.

In some embodiments, module 612 may also assess contact risk factors include sensitivity of file object contacts (i.e. high vs low data value); suspicion level of network target contacts (trusted vs untrusted network contacts, presence on network threat watch lists, etc.); data transfer volume over the contact; temporal proximity to other contacts (e.g. high read volume from a sensitive file object followed by high transmit volume to a suspect network contact); and overall pattern or rhythm or intensity of observed contact traffic.

In some embodiments, module 612 may also consider enterprise risk factors such as current cyber threat environment, including globally, by region or locale, by enterprise type or industry vertical, etc.; current enterprise attack activity level, for example as measured by alert status, denial of service traffic, compromise indicators, intrusion detectors, etc.; and current enterprise digital asset values and target attractiveness.

In some embodiments, module 612 may also consider system fitness factors such as event log indicators including indicators of system crashes and application crashes; system stress indicators including system resource utilizations; and system performance indicators including boot times, time interval since last boot or last Patch Tuesday, and network spike times.

In some embodiments, module 612 may also consider workload mix factors such as active components including binary risk scores or load module scores.

In some embodiments, module 612 may also consider network activity factors such as enterprise intranet connectivity and external Internet connectivity including suspect geographies, suspect domains, and suspect IP addresses.

In some embodiments, module 612 may also consider additional factors for assessing risk such as those discussed below with respect to Appendix A.

Performance profile module 614 is representative of program instructions executable to dynamically determine performance profiles that include one or more scores identifying assessed performance for a computer system or its components. Profiles determined by module 614 may be usable by algorithm 608 in conjunction with policy 606 to govern the extent, level, and detail of continuous observation point monitoring and/or determine control actions to be taken based upon analyzed performance factors. As with risk profiles, module 614 may produce a respective performance profile for each monitored observation point 602 or may produce a performance profile for a group of points 602. In producing a performance profile, in some embodiments, module 614 may consider performance factors such as system hardware/software capabilities and capacities; system resource utilization levels for processor, memory, and input/output resources; network utilization and performance levels; application performance levels, including user response times; network stress indicators, including packet transit times, packet loss rate and retries, network congestion levels, queue depths and queuing delays, etc.; and service level objectives, for example, as specified by service level agreements.

Operational state profile module 616 is representative of program instructions executable to dynamically determine operation state profiles that include one or more scores identifying assessed operational states for a computer system or its components. Profiles determined by module 616 may be usable by algorithm 608 in conjunction with policy 606 to govern the extent, level, and detail of continuous observation point monitoring and/or determine control actions based upon analyzed operational state factors. As with risk and performance profiles, module 616 may produce a respective operation state profile for each monitored observation point 602 or may produce an operation state profile for a group of points 602. In producing an operation state profile, in some embodiments, module 616 may analyze operational state factors such as system stress indicators, including resource saturations, excessive fault indications (including process or service hangs and crashes) or system crashes; user presence or absence, either locally and/or remotely; user activity patterns, including current and recent past focus applications and normal working hours; user authority and trust level; date/time characteristics and normal work schedules, scheduled events and activities, periodic (hourly, daily, weekly, monthly, quarterly, or annual) patterns, etc.; on or off network operation, and network characteristics; attached devices, including removable storage devices, network and wireless interfaces, etc.; current workload, including active applications and system processes; expected workflows; and regulatory requirements.

Turning now to FIG. 7, an exemplary method 700 for dynamically assessing computer system activity information is depicted. Method 700 is one embodiment of a method that may be performed by a computing device implementing algorithm 608. As depicted, method 700 includes steps 710, 720, and 730.

In step 710, information is received from observation instrumentation (e.g., one or more endpoint computer systems 120, agents 340 within systems 120, or other components of network 110 such switches, gateways, routers, etc.) that monitors a plurality of observation points (e.g., observation points 602) in a computer system such as network 110. This received information may include information identifying activities occurring in the computer system and observed by the observation instrumentation. In some embodiments, the received information includes user activity risk factors, system risk factors, application risk factors, contact risk factors, enterprise risk factors, or any of the additional risk factors mentioned above. In some embodiments, the received information includes performance information associated with the computer system (or one or more components in the computer system) such as information identifying capabilities of the computer system, resource utilizations associated with one or more components of the computer system, or any other performance information such as discussed above. In some embodiments, the received information includes operation state information associated with the computer system such as system stress indicators, an indication of user presence, an indication of system workload, or any other operation state information discussed above.

In step 720, a risk profile associated with the computer system is determined from the received information. In some embodiments, step 720 also includes determining, from the received information, a performance profile for one or more components in the computer system and/or an operation state profile for one or more components in the computer system.

In step 730, based on the risk profile, an adjustment is made how the observation instrumentation monitors the plurality of observation points. In some embodiments, the adjustment includes increasing or decreasing a frequency at which the observation instrumentation monitors one of the observations points. In some embodiments, the adjustment includes instructing the observation instrumentation to monitor a subset of the plurality of observation points. In some embodiments, the adjustment includes causing the observation instrumentation to collect additional information about one of the plurality of observation points. In some embodiments, the observation instrumentation collects more information than the amount of information received from the observation instrumentation, and the adjusting includes controlling 1) how much of the collected information is stored by one or more caches or 2) how long the collected information is stored by the one or more caches. In some embodiments, this additional information may go beyond merely collecting metadata about what is occurring in the computer system and include collecting more detailed information such as network traffic content produced by the computer system when warranted by risk level or traffic sensitivity. In some embodiments, the adjustment is also based on a performance profile and/or an operation state profile determined in step 720. In some embodiments, step 730 includes causing, based on the risk assessment profile, a control action to be taken with respect to one or more components in the computer system. In some embodiments, step 730 includes evaluating the risk profile against a stored policy defining a set of criteria for monitoring the plurality of observation points, and based on the evaluating, adjusting how the observation instrumentation monitors the plurality of observation points.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory computer readable medium having stored thereon instructions that are executable by a computing device to perform operations comprising:
receiving information from observation instrumentation that monitors a plurality of observation points in a computer system, wherein the information includes information identifying activities occurring in the computer system and observed by the observation instrumentation;
determining, from the received information, a risk profile associated with the computer system; and
based on the risk profile, adjusting how the observation instrumentation monitors the plurality of observation points.

2. The computer readable medium of claim 1, wherein the received information includes information about one or more user activity risk factors, wherein the user activity risk factors include a presence of user activity, a privilege level of a user, whether a user is logged in locally or remotely to the computer system, information about a user's focus, and a login period.

3. The computer readable medium of claim 1, wherein the received information includes information about one or more system risk factors, wherein the system risk factors include a system hardware configuration, a system software configuration, a system stress level, a conformity with enterprise security and management requirements, and observed suspicion indicators.

4. The computer readable medium of claim 1, wherein the received information includes information about one or more application risk factors, wherein the application risk factors include an application trust level, an application's prevalence across the computer system, a likelihood that an application's execution is performed responsive to a user's instruction, and a manner in which an application accesses data in a file system or over a network.

5. The computer readable medium of claim 1, wherein the received information includes information about contact risk factors and enterprise risk factors.

6. The computer readable medium of claim 1, wherein the received information includes performance information associated with one or more components in the computer system, wherein the operations further comprise:
determining, from the received information, a performance profile for one or more components in the computer system; and
based on the performance profile, adjusting how the agents monitor the plurality of observation points.

7. The computer readable medium of claim 6, wherein the performance information identifies capabilities for one or more components of a network or resource utilizations associated with one or more components of the network.

8. The computer readable medium of claim 7, wherein the performance information includes one or more of system hardware or software capabilities, system resource utilization levels, network performance levels, application performance levels, network stress indicators, and service level objectives.

9. The computer readable medium of claim 1, wherein the received information includes operation state information associated with one or more components in the computer system, wherein the operations further comprise:
determining, from the received information, an operation state profile for one or more components in the computer system; and
based on the operation state profile, adjusting how the observation instrumentation monitors the plurality of observation points.

10. The computer readable medium of claim 9, wherein the operation state information includes system stress indicators, an indication of user presence, user activity patterns, user trust level, network characteristics, an indication of attached devices, an indication of current or expected system workload, or regulatory requirements.

11. The computer readable medium of claim 1, wherein the adjusting includes increasing or decreasing a frequency at which the observation instrumentation monitors one of the observations points.

12. The computer readable medium of claim 1, wherein the adjusting includes controlling an amount of information received from the observation instrumentation.

13. The computer readable medium of claim 12, wherein the observation instrumentation collects more information than the amount of information received from the observation instrumentation, wherein the observation instrumentation stores the collected information into one or more caches, and wherein the adjusting includes controlling 1) how much of the collected information is stored by the one or more caches or 2) how long the collected information is stored by the one or more caches.

14. The computer readable medium of claim 1, wherein the operations further comprise:
based on the risk profile, causing a control action to be taken with respect to one or more components in the computer system.

15. The computer readable medium of claim 1, wherein the operations further comprise:
storing a policy defining a set of criteria for monitoring the plurality of observation points;
evaluating the risk profile against the stored policy; and
based on the evaluating, adjusting how the agents monitor the plurality of observation points.

16. The computer readable medium of claim 1, wherein the computer system is a network having a plurality of endpoint computing devices, wherein ones of the plurality of observation points reside at ones of the plurality of endpoint computing devices.

17. The computer readable medium of claim 16, wherein the received information includes network flow information associated with the network.

18. A non-transitory computer readable medium having stored thereon instructions that are executable by a computing device to perform operations comprising:
receiving information from a plurality of observation points in a computer system, wherein the information identifies activities occurring in the computer system and that are indicative of the computer system's potential security risk;
determining, from the received information, a risk profile associated with the computer system; and
based on the risk profile, causing one or more control actions to be taken at one or more control points in the computer system.

19. The computer readable medium of claim 18, wherein the one or more control actions include one or more of the following cyber-security risk actions:
process suspension or termination, restricting an application, restricting a user, restricting network access, restricting device usage, taking a memory dump, providing an alert, adjusting an extent of monitoring at the plurality of observation points, adjusting a degree of storage for the received information, and adjusting an endpoint security policy.

20. The computer readable medium of claim 18, wherein the one or more control actions include one or more of the following performance actions:
suspending or terminating a process based on a priority of the process, adjusting a priority of a process, rescheduling a process, adjusting a network priority, and adjusting an extent of monitoring at the plurality of observation points.

21. The computer readable medium of claim 18, wherein the one or more control actions include one or more of the following operational state actions:
restricting workload activity, restricting network activity, restricting device attachment, and managing storage or resource consumption at the plurality of observation points or at the one or more control points.

22. A computer system, comprising:
a plurality of collectors configured to collect information from a plurality of observation points in the computer system, wherein the collected information includes cyber-security data, performance data, and operation state data about the computer system; and
one or more analyzers configured to:
analyze the collected information to determine one or more profiles for the computer system; and
based on the one or more profiles, cause one or more control actions to be taken at one or more control points in the computer system.

23. The computer system of claim 22, wherein the one or more control actions include adjusting an extent that ones of the plurality of collectors monitor the plurality of observation points.
